(19) United States
(12) Patent Application Publication
(10) Pub. No.: US 2024/0122215 A1
(43) Pub. Date: Apr. 18, 2024

(54) METHODS AND SYSTEMS FOR PREPARING AND SHIPPING BROTH PRODUCTS

(71) Applicants: Jessica Carrington, Sand Point, ID (US); Paul Carrington, Sand Point, ID (US)

(72) Inventors: Jessica Carrington, Sand Point, ID (US); Paul Carrington, Sand Point, ID (US)

(21) Appl. No.: 18/378,869

(22) Filed: Oct. 11, 2023

Related U.S. Application Data
(60) Provisional application No. 63/415,757, filed on Oct. 13, 2022.

(51) Int. Cl. A23L 3/44; A23L 5/10; A23L 5/20

(52) U.S. Cl. CPC A23L 3/44; A23L 5/13; A23L 5/20; A23V 2002/00

(57) ABSTRACT

Systems and methods are provided for creating unique broths products and preparing them for shipping. The broth products may be created by pouring the liquid broth product into a thin (i.e. shallow) sheet pan. Then freezing the broth filled sheet pan(s). The frozen trays are then freeze dried for approximately 30 hours until completely desiccated. During the 30-hour freeze-drying period, the unique broth product will solidify into a sheet of solid broth product and will split into random, irregularly shaped wafer-like chunks that can be packaged and shipped long distances, dropped into a cup or bowl and reconstituted with water.

### TECHNICAL FIELD

The present application provides improved systems and methods for preparing and shipping broth products to customers. Most broth products sold in commerce are sold and shipped as the familiar dried bouillon cubes or a powder, both of which are prepared for consumption by adding water. Conventional preparation methods are described, for example in, U.S. Pat. No. 6,793,948 to Okada and U.S. Pat. Publication 2011/0171361 to Jung.

### RELATED APPLICATIONS

This utility application claims priority from U.S. Provisional Application 63/415,757 which was filed on Oct. 13, 2022 and is incorporated herein by reference in its entirety.

### BACKGROUND

In order to make chicken bouillon or consommé from chicken bones, chicken meat, and vegetables for hotel, restaurant, and household use, known techniques require anywhere from several hours, to in excess of ten hours, to complete the extraction process. The quality and taste of the product depends on the skill and experience of the person preparing the chicken bouillon or consommé. Thus, it is difficult to maintain uniform product quality and flavor in small batches.

Traditional cooking methods for extracting high quality broth/stock, from raw meat and/or bones, requires placing the raw meat and/or bones in boiling water, and continuing the extraction for a long period of time, from several hours to over ten hours. Further, in order to produce high quality broth, the production process requires complicated work involving heat adjustment, scum removal, filtration, liquid clarification, and reducing it down to the proper concentration. The experience and skill level of the person preparing the soup can have a significant impact on product quality, making it difficult to maintain product uniformity. Solid bouillon or consommé products currently on the market tend to be made with large quantities of added salt and artificial seasonings to enhance the otherwise weak flavor. Such traditional products tend to otherwise be bland. These products have an impaired consumer acceptance. Shipping liquid product with a more satisfying flavor is expensive due to the necessity of having to ship high volumes of water.

As used herein, a broth shall be interpreted to be a term encompassing a soup, bouillon, or stock, or other food product intended to be consumed as a liquid, without regard for solids concentration. These products are related as follows. A bouillon and broth are equivalent French and English terms, respectively, for boiled meat, fowl or fish soup. A consommé is a clarified broth product prepared according to a traditional recipe. A stock is a broth which is used as a starting point for recipes.

### BRIEF SUMMARY

Methods and Systems are provided for creating unique broths products and preparing them for shipping. The broth products may be created by pouring the liquid broth product into a thin (i.e. shallow) sheet pan. Then, freezing the broth filled sheet pan(s). The frozen trays are then freeze dried for a period of time. An exemplary, non-limiting period is 30 hours. During the freeze-drying period, the unique broth product will solidify into a thin sheet of solid, light, flaky, broth product and will split into random, irregularly shaped wafer-like, desiccated chunks that can be packaged and shipped long distances, dropped into a cup or bowl and reconstituted with water. The internal structure of the thin desiccated chunks is a lattice structure, which reduces its density and accelerates its reconstitution in plain water, flavored water or other desired liquid. By lattice structure it is meant that the wafer chunks may have non-vertical, randomly oblique wall like formations between a top and bottom layer of the wafer.

### BRIEF DESCRIPTION OF THE DRAWINGS

The present invention will hereinafter be described in conjunction with the following drawing FIGURES, wherein like numerals denote like elements.

FIG. 1 is a block flow diagram of the methods disclosed herein.

FIG. 2 is a diagram of the equipment used in the methods and systems disclosed herein.

FIG. 3 contains various unique broth recipes for use with the processes of FIG. 1 and FIG. 2

### DETAILED DESCRIPTION

The following detailed description is merely exemplary in nature and is not intended to limit the invention, or the application, or uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention defined by the claims. Further, there is no intention to be bound by any expressed or implied theory presented in the preceding technical field, background, brief summary, or the following detailed description. Any express dimensions, measurements or ratios mentioned herein are exemplary only and are not intended to be limiting.

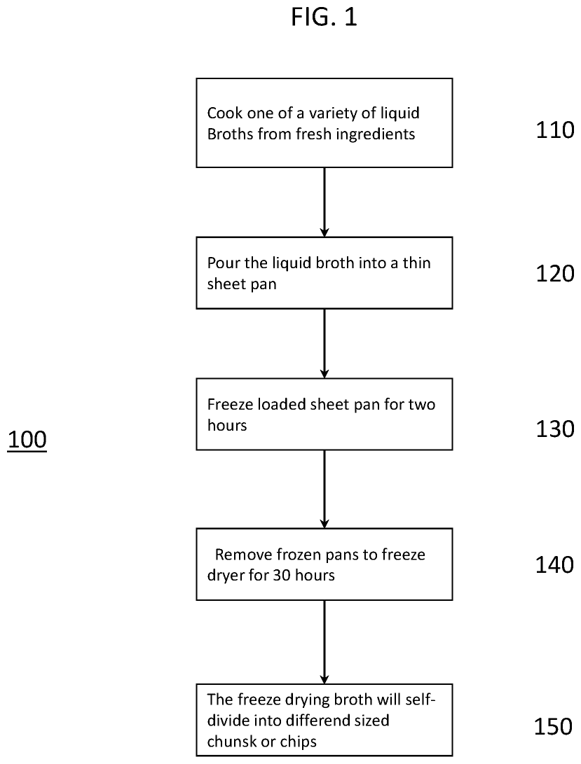

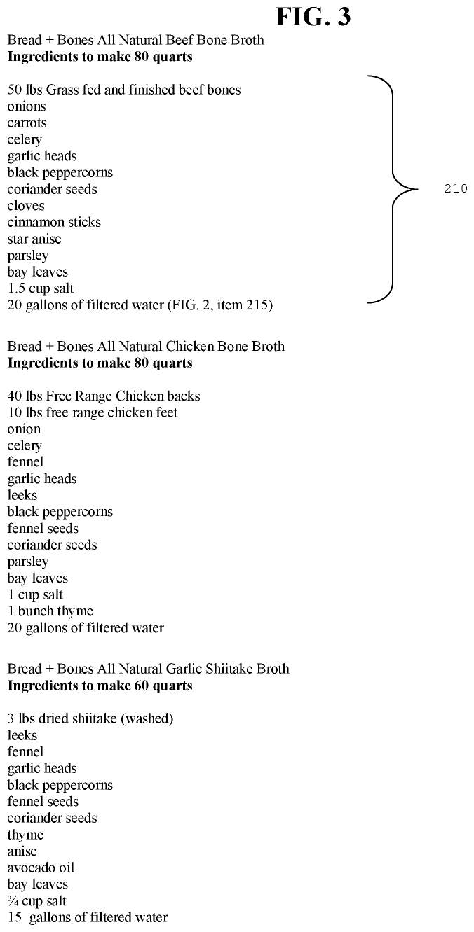

FIG. 1 is a block flow diagram depicting a method 100 for creating the broth products described herein. At process 110, one or more broth batches of variable volume are created from a water-based recipe from ingredients such as those listed in FIG. 3. To prepare a batch of Beef Bone broth, first clean all produce. Then add all ingredients 210 to a large pot 220 and bring the water 215 in the pot to a boil and simmer for a period of hours. An exemplary period of hours may be from 12-20 hours, but preferably 17-19 hours. After simmering, strain the resulting suspension through a fine mesh sieve (not shown), removing and keeping the liquid. Discard bones and vegetables. Bring the liquid to room temperature within a period of minutes (a “chill down”), then portion the liquid into quart containers (not shown). The chill down period may range from 60-120 minutes, but more preferably a period of 80-100 minutes. After the chill down, Freeze the containers. Broth can be kept in the freezer for 6 months. And can be stored in the refrigerator for up to 7 days.

Alternatively, the novel broth product may be created by pouring the liquid from process 110 into a thin (i.e. shallow) sheet pan 230. Then freezing the broth filled sheet pan(s) 230 for a time period at process 130. An exemplary freezing period may take 2-5 hours but more preferably 90 minutes to 3 hours. The frozen trays are then placed into a commercial freeze dryer 240 for a drying period at process 140. The drying period may take 20-40 hours but more preferable 25-35 hours. During the freeze-drying period, the unique broth product will solidify into a sheet of desiccated, solid, flaky broth product and will split into random, irregularly shaped wafer-like chunks that can be packaged and shipped long distances, dropped into a cup or bowl, and then reconstituted with water. It will be noted that failing to completely dehydrate the product may result in spoilage during storage and/or shipping.

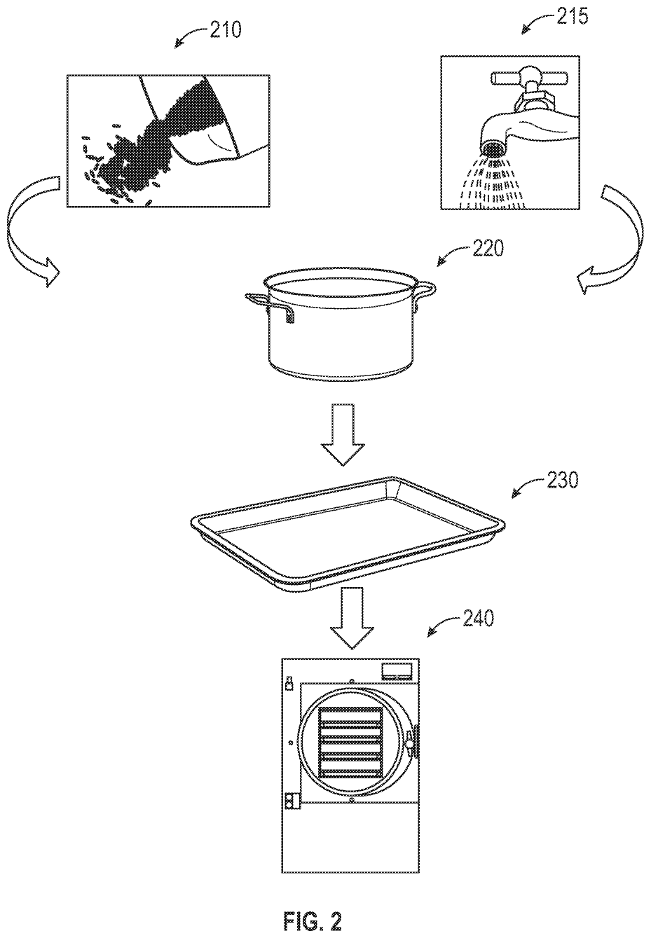

For Chicken Bone Broth a slightly different embodiment of process 100 is used. At process 110, one of a number of broth batches are created from a water-based recipe such as those listed in FIG. 3. To prepare a batch of Chicken Bone broth, first clean all produce. Then add all ingredients 210 to a large pot 220 and bring the water 215 in the pot to a boil and simmer. After simmering, strain the resulting suspension through a fine mesh sieve (not shown), removing and keeping the liquid. Discard bones and vegetables. Chill the liquid to room temperature within the chill period then portion the liquid into quart containers (not shown). Freeze the containers. Broth can be kept in the freezer for 6 months. And can be stored in the refrigerator for up to 7 days. This Chicken Bone Broth may be prepared for shipping in the same manner as the process of FIG. 2.

For Natural Garlic Shitake Mushroom Broth another slightly different embodiment of process 100 is used. At process 110, one of a number of broth batches are created from a water-based recipe such as those listed in FIG. 3. To prepare a batch of Shitake broth, first clean all produce, particularly the Shitake. Fry the Shitake in a large pot 220 with garlic until it is golden brown and then add all for the spices and cook until it is aromatic. Then add all the other ingredients 210 and water to the large pot 220 and bring the water 215 to a boil and simmer for preferably 4 hours. After simmering, strain the resulting suspension through a fine mesh sieve (not shown), removing and keeping the liquid. Discard vegetables. Chill the liquid to room temperature within then portion the liquid into quart containers (not shown). Freeze the containers. Broth can be kept in the freezer for 6 months. And can be stored in the refrigerator for up to 7 days. Shitake Mushroom Broth may be prepared for shipping in the same manner as the process of FIG. 2.

The processes described above when alternatively freeze-dried produces shards of a desiccated fluffy, light, solid wafer that can be packaged directly and shipped with no spoilage. An alternative product may be produced with essentially the same equipment except that the product has a harder, more solid consistency.

What is claimed is:

1. A method of manufacturing a fluffy, desiccated, wafer-like broth product comprising:
extracting a liquid broth from a set of chosen ingredients;
straining off the resulting broth liquid into a tray-like sheet pan;
freezing the strained liquid and sheet pan for a specified time until frozen; and
freeze drying the frozen strained liquid until desiccated.

2. A broth product comprising:
a desiccated wafer-like shard further comprising,
a flaky top layer;
a flaky bottom layer; and
at least one wall structure between the top and the bottom layer.

3. The broth product of claim 2, wherein the at least one wall structure is one of a vertical wall structure and an oblique wall structure.

4. A system for manufacturing a fluffy, wafer-like broth product comprising:
broth ingredients;
at least one extraction container wherein the ingredients are rendered for a specified time in a liquid to produce a broth;
at least one tray-like sheet pan wherein the broth is poured and frozen for a specified time; and
a freeze dryer configure to hold the at least one tray-like sheet pan and dry the broth until desiccated into shards of a thin, wafer with a flaky top layer, a flaky bottom layer, and at least one wall structure between the top and the bottom layer.
